(19) United States
(12) Patent Application Publication
(10) Pub. No.: US 2007/0035817 A1
(43) Pub. Date: Feb. 15, 2007

(54) Collimatable mirror diagonal for telescopes

(76) Inventor: William C. Burgess, Knoxville, TN (US)

Correspondence Address: KNOX PATENTS, P.O. BOX 30034, KNOXVILLE, TN, 37930-0034, US

(21) Appl. No.: 11/461,949

(22) Filed: Aug. 2, 2006

Related U.S. Application Data
(60) Provisional application No. 60/705,056, filed on Aug. 3, 2005.

(51) Int. Cl. G02B 23/00

(52) U.S. Cl. 359/366

(57) ABSTRACT

An apparatus for collimating a diagonal mirror. The diagonal has a 45° mirror with adjustment screws for aligning the mirror precisely with the optical axis of the telescope. The mirror is adjacent a back plate attached to the diagonal body. In one embodiment, a resilient pad is between the mirror and a ledge inside the diagonal body. The back plate has a plurality of threaded openings for receiving collimation setscrews that push the mirror at selected points, thereby moving the mirror to be precisely aligned with the optical axis. In another embodiment, the resilient pad is between the mirror and the back plate. The mirror includes a reflective surface and a base, which has threaded openings. The collimation screws pass through the plate, through the pad, and into the threaded openings in the mirror base, and the screws pull the mirror to compress the pad.

### CROSS-REFERENCE TO RELATED APPLICATIONS

This application claims the benefit of U.S. Provisional Application No. 60/705,056, filed Aug. 3, 2005.

### STATEMENT REGARDING FEDERALLY SPONSORED RESEARCH OR DEVELOPMENT

Not Applicable

### BACKGROUND OF THE INVENTION

1. Field of Invention

This invention pertains to an adjustable diagonal adapted for use near the eyepiece end of a telescope. More particularly, this invention pertains to a diagonal with a 45° mirror with collimation screws for aligning the mirror precisely with the optical axis of the telescope.

2. Description of the Related Art

Two common types of telescopes are refractors and reflectors. Refractors have an objective lens that directs light along an optical axis. Reflectors employ a mirror, often either parabolic or spherical, to redirect the light along an optical axis. Some reflectors employ a lens in front of the mirror and are known as catadioptric telescopes, such as the Maksutov Cassegrain and the Schmidt-Cassegrain telescope (SCT). Both types of telescopes employ a focuser having a mechanism for attaching an eyepiece. The focuser moves the eyepiece along the optical axis until the eyepiece focal plane coincides with the focal plane of the objective lens or mirror.

When using a refracting or a catadioptric type telescope to observe an object near the zenith, that is, when the telescope is aimed nearly straight up, it is often inconvenient for an observer to position their eye along the optical axis. To make visual observing more comfortable, it is common to add a diagonal mirror in the optical path to redirect the light to a more convenient direction for the observer. Right angle diagonals redirect the optical path 90°, thereby allowing an observer to look horizontally when the telescope is pointed vertically. Telescope diagonals typically have a barrel that is inserted into the end of the focuser and an eyepiece or other accessory is inserted into the other end of the diagonal. Refractors and catadioptric telescopes are often used with a diagonal.

In order to maintain optimum performance of a telescope, proper alignment of the elements in the optical path is crucial. The objective lens of refractors are collimated to align the optical path of the lens with the axis of the focuser at the opposite end of the optical tube assembly. The mirrors of reflectors are frequently collimated to ensure the optical path is aligned with the axis of the focuser. Because diagonals redirect the optical path, they too must be properly aligned. But, telescope diagonals traditionally have mirrors that are fixed. In order to collimate these diagonals, the mirror must be shimmed, which is a time consuming process subject to errors. Accordingly, there is a need for a telescope diagonal that is easily collimatable.

### BRIEF SUMMARY OF THE INVENTION

According to one embodiment of the present invention, a collimatable telescope diagonal is provided. The diagonal has a mirror at 45° relative to the optical axis of the objective lens. The diagonal includes adjustment screws for aligning the mirror precisely with the optical axis of the telescope. The mirror is mounted to a back plate, which attaches to the diagonal body. Between the mirror and the back plate is a resilient pad. In one embodiment, the resilient pad is adhered to the back plate and the mirror. The back plate has a plurality of threaded openings for receiving collimation setscrews. The collimation setscrews push the mirror at selected points, thereby positioning the mirror and allowing the mirror to be precisely aligned with the optical axis.

In one embodiment, the diagonal has four collimation screws arranged in a diamond pattern on the back plate. In another embodiment, the diagonal has three collimation screws arranged in a triangular pattern on the back plate. In still another embodiment, the diagonal has two collimation screws and a fixed, raised point, and the mirror is collimated by adjusting the two collimation screws relative to the fixed, raised point.

Another embodiment of the collimatable telescope diagonal includes a mirror assembly having a reflective surface and a base. The mirror base is connected to a back plate that attaches to the diagonal body. Between the back plate and the mirror base is a resilient pad that is compressed by collimation screws that pass through the plate and the pad and that engage threaded openings in the mirror base. The compressed resilient pad acts as a spring to force the mirror away from the plate. The mirror is collimated by selectively adjusting the collimation screws.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a exploded side view of a collimatable diagonal;

FIG. 2 is a plan view of one embodiment of the resilient foam pad;

FIG. 3 is a bottom view of one embodiment of the back plate;

FIG. 4 is a perspective view of one embodiment of the back plate;

FIG. 5 is a symbolic perspective view of one embodiment of the collimation vectors;

FIG. 6 is a cross-sectional view of a portion of one embodiment of the diagonal;

FIG. 7 is a cross-sectional view of a one embodiment of a collimation screw and threaded opening;

FIG. 8 is an oblique view of another embodiment of a collimatable diagonal;

FIG. 9 a side view of the embodiment of the collimatable diagonal of FIG. 8; and

FIG. 10 is an angled view showing the adjustment assembly of the embodiment of the collimatable diagonal of FIG. 8.

### DETAILED DESCRIPTION OF THE INVENTION

An apparatus for collimating a telescope diagonal is disclosed. The diagonal 100 is adapted to be used with a telescope, such as an astronomical telescope, in which the optical path is to be redirected.

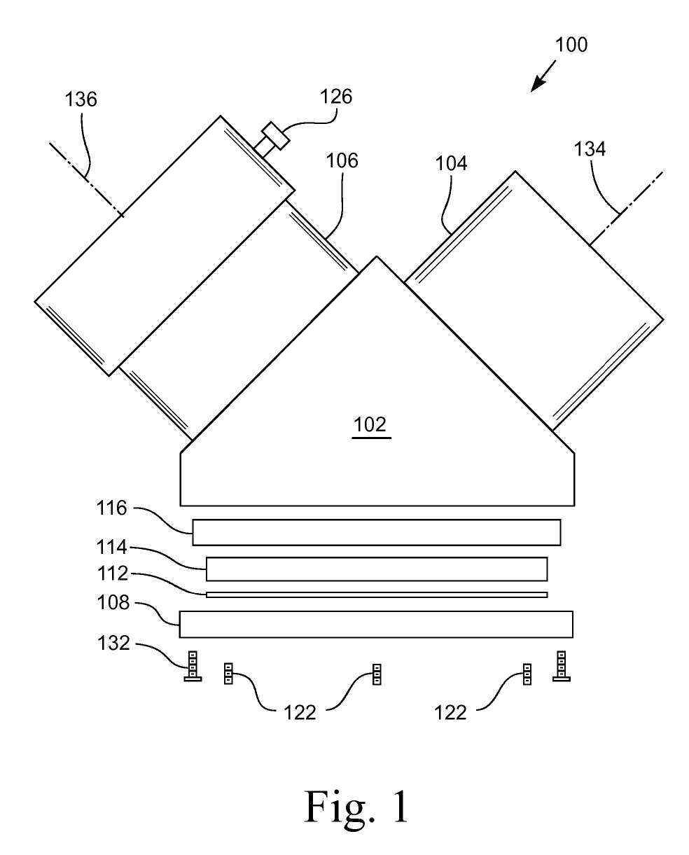

FIG. 1 illustrates an exploded side view of a collimatable, or adjustable, diagonal 100. Attached to the illustrated diagonal body 102 are a barrel 104 and an eyepiece accessory holder 106 with their optical axes 134, 136 at a precise 90° angle to each other. Although the illustrated embodiment is a right angle diagonal 100, those skilled in the art will recognize that the optical axis 134, 136 can be at a selected angle other than 90°.

The barrel 104 is the input port of the diagonal 100. The barrel, or attachment device, 104 in the illustrated embodiment is a cylindrical member adapted to be received by or mate with a focuser or other opening in an optical tube assembly, or telescope. The barrel 104 has a longitudinal axis 134 that coincides with the optical axis through the objective lens. In one embodiment, the barrel 104 is adapted to mate with a threaded adaptor, such as used on many Schmidt-Cassegrain telescopes.

The eyepiece accessory holder 106 is the output port of the diagonal 100. The eyepiece holder 106 has a cylindrical through-opening adapted to receive or mate with a telescope accessory, such as an eyepiece, a binoviewer, or a relay lens. The eyepiece holder 106 has a longitudinal axis 136 that coincides with the optical axis through the eyepiece or other accessory mated to the holder 106. In the illustrated embodiment, the holder 106 includes a thumbscrew 126 for locking or securing the accessory to the holder 106.

The diagonal 100 includes a mirror 114 that reflects light coming in through the barrel 104. The mirror 114 is a first surface mirror that must be held in a precise position. For optimum functioning of the optics, light following the longitudinal axis 134 of the barrel 134, that is, the optical axis of the input, must be reflected to follow the longitudinal axis 136 of the holder 106, that is, the optical axis of the output. Misalignment of the mirror 114 will cause the output optical axis to not coincide with the longitudinal axis 136 of the holder 106. Not only must the mirror 114 be held in precise alignment, but the reflective surface of the mirror 114 must be maintained within a tight tolerance of being perfectly flat.

The diagonal body 102 has a recessed portion at the bottom into which fits a resilient pad 116, a mirror 114, and a backing plate 112. The pad 116, the mirror 114, and the backing plate 112 are held captive in the diagonal body 102 by the diagonal back plate 108. The back plate 108 is secured to the diagonal body 102 by four fasteners 132, which screw into threaded openings in the diagonal body 102.

In one embodiment, the barrel 104 and the holder 106 have threaded ends that engage threaded openings in the diagonal body 102. In another embodiment, the barrel 104, the holder 106, and the diagonal body 102 are machined from a solid piece of metal.

In the illustrated embodiment, the diagonal back plate 108 includes four threaded openings that receive x-axis collimation setscrews 122X and y-axis collimation setscrews 122Y. The collimation setscrews 122 protrude through the back plate 108 and press against the backing plate 112, which is adjacent the mirror 114. In one embodiment, the backing plate 112 is adhered to the back of the mirror 114. In another embodiment, the backing plate 112 has no intervening material adjacent the mirror 114. In still another embodiment, a resilient sheet, such as a vinyl layer, is positioned between the backing plate 112 and the back of the mirror 114. The backing plate 112 receives the point load from each of the setscrews 122 and distributes that point load from each setscrew 122 over a larger area, which is transmitted to the mirror 114, thereby avoiding any point distortion of the mirror 114. In one embodiment, the backing plate 112 is made of T75 aluminum plate, which exhibits high stiffness with thin cross-sections.

Between the mirror 114 and the diagonal body 102 is the pad 116. The pad 116 is made of a resilient material, such as an open cell foam, that continually biases the mirror 114 away from the diagonal body 102 toward the diagonal back plate 108. That is, the pad 116 acts as a spring pushing against the front of the mirror 114. As the collimation setscrews 122 push the backing plate 112, and consequently the mirror 114, away from the back plate 108, the pad 116 returns that push, thereby holding the mirror 114 in a stable position.

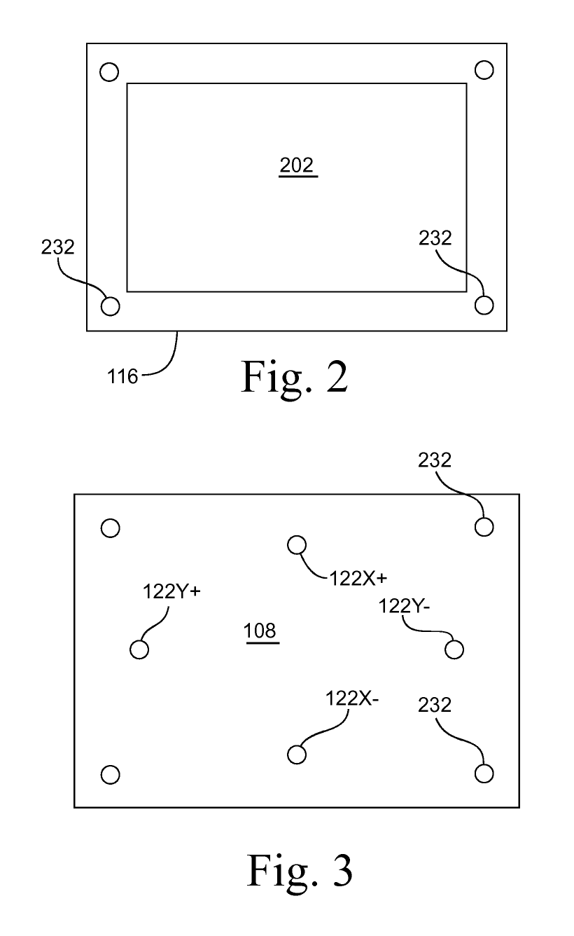

FIG. 2 illustrates a plan view of one embodiment of the resilient foam pad 116. The illustrated pad 116 is substantially rectangular with an opening 202 formed in the middle of the pad 116. The opening 202 is sized to allow the full light path from the barrel 104 to pass through to the eyepiece holder 106 without vignetting. The opening 202 is also sized to be smaller than the mirror 114 such that the front face of the mirror 114 is in contact with the pad 116 around the periphery of the opening 202. Those skilled in the art will recognize that the area of the mirror that reflects light from the barrel 134 has an elliptical shape. Accordingly, in other embodiments, the mirror 114 has an outside shape that is not rectangular, and the opening 202 in the pad 116 has a corresponding shape that does not restrict the light passing from the barrel 106 to the eyepiece holder 106.

In the illustrated embodiment, the pad 116 has openings 232 that allow the diagonal fasteners 132 to pass through. In another embodiment, the openings 232 are sized such that a shoulder surrounding the threaded openings in the diagonal body 102 protrude into the openings 232 such that fastening the diagonal back plate 108 to the diagonal body 102 does not compress the pad 116.

FIG. 3 illustrates a bottom view of one embodiment of the back plate 108 showing each of the fasteners 132 positioned at each of the corners of the back plate 108. In the illustrated embodiment, four collimation setscrews 122 are shown positioned between the fasteners 132. The collimation setscrews 122 form the points of a diamond pattern. In another embodiment, three collimation setscrews are used, with the setscrews forming the points of a triangle. In still another embodiment, two collimation setscrews are used along with a fixed point that holds the backing plate 112 a fixed distance from the diagonal back plate 108. The two setscrews and the fixed point form the points of a triangular pattern.

In the illustrated embodiment the four collimation screws 122 are shown oriented along the x-axis 504 and the y-axis 502, relative to the mirror 114. Those skilled in the art will recognize that the collimation screws 122 can be positioned at other locations relative to the mirror 114 without departing from the spirit and scope of the present invention.

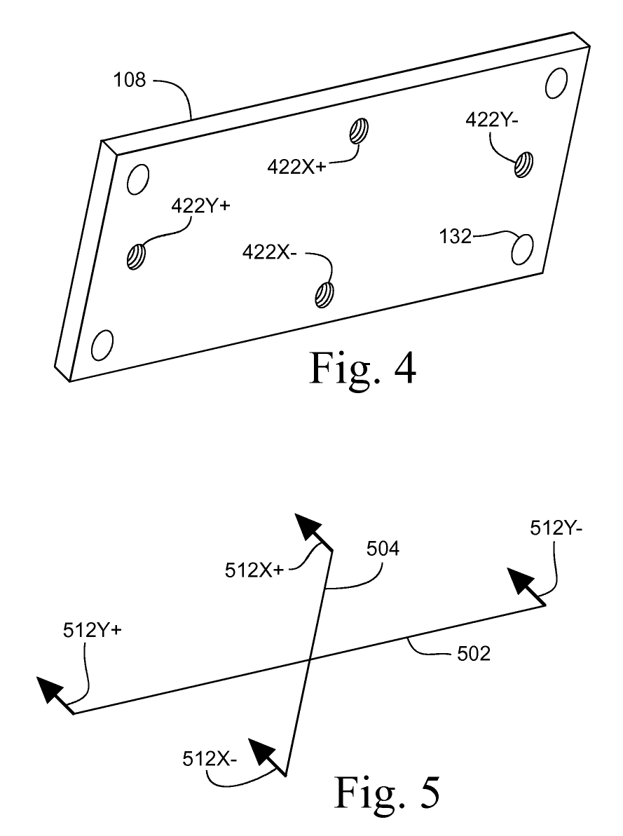

FIG. 4 illustrates a perspective view of one embodiment of the diagonal back plate 108. The back plate 108 includes threaded openings 522 that receive the collimation setscrews 122. FIG. 5 illustrates a symbolic perspective view of one embodiment of the collimation vectors 512 for the back plate 108 oriented as illustrated in FIG. 4. The x-axis 504 of the mirror 114 and the y-axis 502 of the mirror 114 are illustrated in FIG. 5. As a collimation screw 122 is adjusted, the associated axis 502, 504 is tilted as indicated by the collimation vectors 512. For example, if the collimation screw 122Y+ associated with the collimation vector 512Y+ is screwed in and the opposite collimation screw 122Y− associated with the collimation vector 512Y− is screwed out, the y-axis 502 of the mirror is tilted in a corresponding manner. This adjustment will cause the light traveling along the barrel's axis 134 to be reflected in various directions relative to the holder's axis 136. Likewise, adjusting the collimation screws 122X in opposite directions will cause the x-axis 504 to tilt as indicated by the collimation vectors 512X+, 512X−. With four collimation screws 122, the opposing screws must be moved in opposite directions in order for each of the collimation screws 122 to maintain contact with the backing plate 112.

In the embodiment in which three collimation screws 122 are arranged in a triangular pattern, adjustment of any one collimation screw 122 does not require a corresponding adjustment of any other collimation screw 122. However, adjustment of any one of the three collimation screws 122 does not move the mirror 114 along orthogonal axes, rather, adjustment of one of the three collimation screws 122 moves the mirror 114 so that it pivots at a 120° angle relative to each of the other two screws 122. In a similar manner, the embodiment in which two collimation screws 122 are used with a raised, fixed point, adjustment of any one of the two collimation screws 122 moves the mirror 114 as described above with respect to moving any one of three collimation screws 122. However, to move the mirror 114 relative to the fixed point, both of the two collimation screws 122 must be moved in tandem.

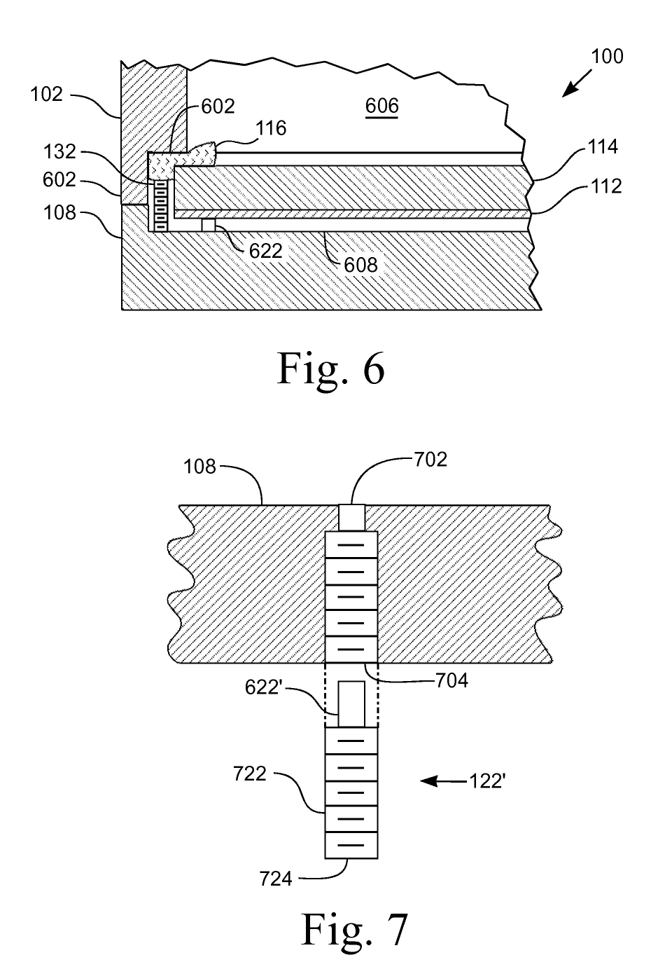

FIG. 6 illustrates a cross-sectional view of a portion of one embodiment of the diagonal 100. In the illustrated embodiment, the diagonal back plate 108 includes a recessed portion 608 into which and end portion 622 of each collimation screw 122 protrudes. In another embodiment, the back plate 108 has a flat surface instead of a recess 608. The backing plate 112 and the mirror 114 are positioned between the end portion 622 of the collimation screws 122 and the pad 116. The diagonal body 102 has an internal cavity 606 and a ledge 602. The pad 116 is squeezed between the ledge 602 and the mirror 114.

With the diagonal 100 assembled and the setscrews 122 not bearing against the backing plate 112, the mirror 114 is sandwiched between the pad 116 and the diagonal back plate 102. Screwing the setscrews 122 into the diagonal back plate 102 such that the setscrew end portions 622 bear against the backing plate 112 causes the mirror to move further into the diagonal cavity 606 as the pad 116 is compressed. With the resilient pad 116 compressed, the pad 116 generates sufficient spring force to securely hold the mirror 114 in position against the setscrews 122. Further adjustment of the setscrews 122 causes the mirror 114 to be aligned such that light reflected from the axis 134 of the barrel 104 coincides with the axis 136 of the holder 106.

FIG. 7 illustrates a cross-sectional view of a another embodiment of a collimation setscrew 122′ and threaded opening 704. In the illustrated embodiment, the collimation setscrew 122′ has a narrow end portion 622′ and a threaded body 722. The setscrew end 724 opposite the narrow end portion 622′ includes structure for obtaining rotary motion of the collimation screw 122′, for example a slot or a hex socket. The threaded body 722 of the collimation setscrew 122′ is received by a threaded opening 704 in the diagonal back plate 108. The narrow end portion 622′ is received by a narrow opening 702 in the inboard side of the diagonal back plate 108. The length of the end portion 622′ is such that it protrudes through the narrow opening 702 past the inside surface of the diagonal back plate 108.

In the illustrated embodiment, the collimation setscrew 122′ has limited inward travel because the threaded body 722 cannot enter the narrow opening 702 in the diagonal back plate 108. This serves to limit the available movement of the mirror 114 when adjusting the collimation setscrew 122′. It also prevents the screw 122′ from being screwed completed through the back plate 108 in which case the back plate 108 must be removed from the diagonal body 102 to retrieve the loose setscrew 122.

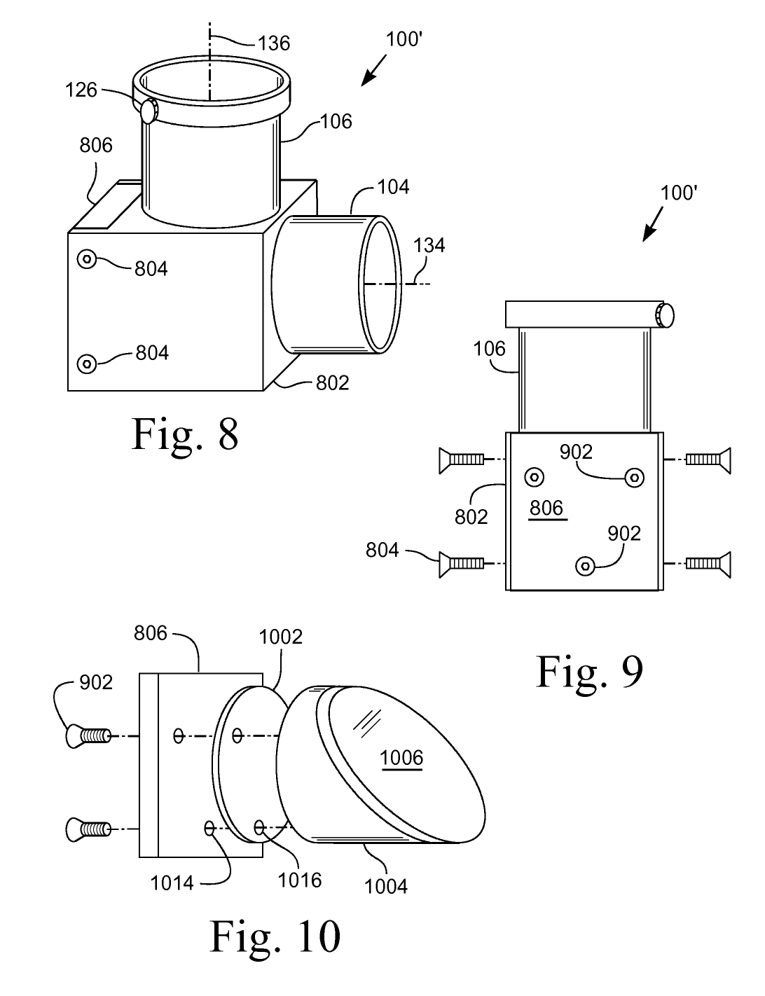

FIG. 8 illustrates an oblique view of another embodiment of a collimatable, or adjustable, diagonal 100′. The illustrated embodiment has a box-shaped diagonal body 802 with a barrel 104 and an eyepiece accessory holder 106. Visible on the side of the diagonal body 802 are securing screws 804 that attach a back plate 806 to the diagonal body 100′. In the illustrated embodiment, a channel is cut in the diagonal body 100′ such that two opposite ends of the plate 806 are flush with two opposite outside surfaces of the diagonal body 100′.

FIG. 9 illustrates a side view of the embodiment of the collimatable diagonal 100′ of FIG. 8. Visible in the diagonal body 802 is a back plate 806 with three collimation screws 904 visible. The collimation screws 902 are shown forming a triangular pattern, that is, each screw 902 is positioned at an apex of an isosceles triangle. In other embodiments, the number of collimation screws can vary without departing from the spirit and scope of the present invention. For example, four collimation screws 902 are arranged at a corner of a square or a diamond-shaped pattern.

The securing screws 804 are illustrated removed from the diagonal 100′. The securing screws 804 engage threaded openings in opposite sides of the back plate 806, thereby securing the back plate 806 to the inside of the diagonal body 802 in a fixed position. In another embodiment, the back plate 806 is attached to the diagonal body 802 with securing screws 804 engaging openings in the four corners of the face of the securing plate 806 adjacent the collimation screws 902. In such an embodiment, the diagonal body 802 has a cylindrical bore, or cavity, the inside corners of the body 802 have threaded openings for the screws 804 to engage.

FIG. 10 illustrates an angled view showing the adjustment assembly of the embodiment of the collimatable diagonal 100′ of FIG. 8. An elliptical-shaped mirror 1006 is attached to a mirror base 1004 that has three threaded openings corresponding to the openings 1014 in the back plate 806 for the collimation screws 902. The mirror base 1004 is cylindrical with a base that is perpendicular to the longitudinal axis of the cylindrical base 1004. The surface of the base 1004 to which the mirror 1006 attaches is cut at a 45° angle to the longitudinal axis of the cylindrical base 1004.

Between the mirror base 1004 and the securing plate 902 is a resilient pad 1002 with openings 1016 corresponding to the openings 1014 in the plate 902. The securing plate 902, the resilient pad 1002 and the mirror base 1004 with attached mirror 1006 are secured together with the collimation screws 902 such that the resilient pad 1002 is slightly compressed between the plate 806 and the mirror base 1004.

The assembled pad 1002, base 1004, and mirror 1006 slide into a bore, or cavity, in the diagonal body 802 such that the mirror 1006 redirects light from the barrel 104 to the eyepiece accessory holder 106. That is, the mirror 1006, with the back plate 806 attached to the diagonal body 802, is oriented such that light passing through the opening through the barrel 104 is reflected through the opening in the eyepiece accessory holder 106. Any mis-alignment is adjusted out with the collimation screws 902. Tightening any one of the three screws 902 compresses the resilient pad 1002 and tilts the mirror base 1004, and the mirror 1006, in a direction of a line between the center of the screws 902 and the collimation screw 902 being tightened.

Various methods are available for collimating the diagonal 100, 100′. One method of adjusting the collimatable diagonal 100 is by aligning a beam from a laser along the optical axis 134, 136 of either the barrel 104 or the holder 106. For the alignment procedure, this is the input optical axis. A target with the intersection of the output optical axis marked is positioned opposite the other of the holder 106 or the barrel 104 at a distance from the diagonal 100, 100′. The further the distance the target is from the diagonal 100, 100′, the greater will be the beam displacement for a specific error in the collimation of the mirror 114. For the embodiment with four collimation setscrew 122, the collimation setscrews 122 are adjusted in pairs (one in, one out) until the beam of the laser strikes the optical axis mark on the target. For the embodiments with two or three collimation setscrews 122, 902, the setscrews 122, 902 are adjusted individually or in tandem (both in or both out) to center the laser beam on the optical axis.

Another method of collimating the diagonal 100, 100′ is by placing the diagonal 100 in a refractor telescope with a laser collimation device inserted in the holder. The laser collimation device has a laser beam aligned with the longitudinal axis of the device, and the device is adapted to be received by the eyepiece holder 106. The collimation setscrews 122, 902 are adjusted such that the laser beam strikes the center of the objective lens. Collimation is verified by rotating the diagonal 100, 100′ around the axis 134 of the barrel 104 and verifying that the intersection of the laser beam with the objective lens does not move.

Yet another method of collimating the diagonal 100, 100′ is by first collimating a refractor with a Cheshire, then placing the diagonal 100, 100′ in a refractor telescope and inserting a Cheshire into the eyepiece holder 106. The collimation setscrews 122, 902 are adjusted until the reflected circles seen in the Cheshire are concentric. A Cheshire with cross-hairs increases the visual accuracy of the collimation. Another type of Cheshire is a telescopic Cheshire, which increases the accuracy of the collimation.

A collimation method often used by amateur astronomers is to place a mirror against the outside opening of the barrel 104 and insert a Cheshire into the eyepiece holder 106. The collimation setscrews 122, 902 are adjusted until the reflected circles seen in the Cheshire are concentric. A Cheshire with cross-hairs increases the visual accuracy of the collimation. Another type of Cheshire is a telescopic Cheshire. Provided the outside surface of the opening of the barrel 104 is flat and perpendicular to the longitudinal axis 134 of the barrel 104, the Cheshire should indicate reflected concentric circles when the diagonal 100 is properly collimated.

Still another method of collimating the diagonal 100, 100′ is by placing the diagonal 100 in a telescope and using an eyepiece that gives approximately 40× to 60× magnification per inch of aperture. The telescope is star tested and the collimation setscrews 122, 902 are adjusted to ensure the star test images are consistent with those of a collimated telescope.

The collimatable diagonal 100, 100′ includes various functions. The function of tilting the mirror 114, 1006 relative to the incoming optical axis 134 is implemented, in one embodiment, by the collimation setscrews 122, 902 engaging the threaded openings 422 in the diagonal back plate 108, 806.

The function of applying a spring force to the mirror 114 is implemented, in one embodiment, by the resilient pad 116 positioned between the mirror 114 and the ledge 602 in the diagonal cavity 606. The pad 116 resists being compressed between the mirror 114 and the ledge 602. In another embodiment, the function of applying a spring force to the mirror 1006 is implemented by the resilient pad 1002 positioned between the mirror base 1004 and the back plate 806. The pad 1002 resists being compressed between the plate 806 and the mirror base 1004.

The function of preventing distortion of the mirror 114 by the collimation setscrews 122 is implemented, in one embodiment, by the backing plate 112 between the setscrews 122 and the mirror 114. The backing plate 112 is a thin, rigid member that spreads the point loading of the setscrews 122 over a large surface area, which bears against the mirror 114. In another embodiment, the function of preventing distortion of the mirror 1006 by the collimation setscrews 902 is implemented by the mirror base 1004 having threaded openings receiving the screws 902, with the base 1004 having an opposite surface to which the mirror 1006 is attached.

From the foregoing description, it will be recognized by those skilled in the art that a collimatable diagonal 100 has been provided. In one embodiment, the collimatable diagonal 100 includes a resilient pad 116 positioned between the cavity of the diagonal body 102 and the diagonal mirror 114. Adjacent the mirror 114 is a backing plate 112. In one embodiment the backing plate 112 is attached to the mirror 114. The backing plate 112 has the ends 622 of the collimation setscrews 122 bearing against it, and the backing plate 112 spreads this point loading over a large surface area to the mirror 114. The setscrews 122, operating against the spring pressure from the compressed pad 116, tilts, or moves, the mirror 114 in order to align, or collimate, reflections from the mirror 114 such that the input optical axis 134 is aligned with the output optical axis 136.

In another embodiment, the collimatable diagonal 100′ includes a resilient pad 1002 positioned between the plate 806 and the mirror base 1004. Collimation screws 902 pass through the plate 806, through the resilient pad 1002, and thread into the mirror base 1004, and, when tightened, the screws compress the resilient pad 1002. The setscrews 902, operating against the spring pressure from the compressed pad 1002, tilt, or move, the mirror 1006 in order to align, or collimate, reflections from the mirror 1006 such that the input optical axis 134 is aligned with the output optical axis 136.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for collimating a diagonal mirror for a telescope, said apparatus comprising:
a diagonal body having a barrel and a holder, said barrel having a barrel axis, said holder having a holder axis, said diagonal body securing said barrel and said holder such that said barrel axis and said holder axis intersect at a specified angle, said diagonal body having a cavity;
a diagonal back plate with a plurality of fasteners for securing said diagonal back plate to said diagonal body, said diagonal back plate adapted to cover said cavity, said diagonal back plate having a plurality of threaded openings;
a mirror that reflects light traveling along said barrel axis to said holder axis, said mirror positioned between said cavity and said diagonal back plate;
a pad positioned between said mirror and said cavity of said diagonal body, said pad being resilient; and
a plurality of collimation screws, each one of said collimation screws received in one of said plurality of threaded openings in said diagonal back plate, said plurality of collimation screws protruding through said diagonal back plate and causing said mirror to be a selected distance from an inside surface of said diagonal back plate, whereby an adjustment of one of said plurality of said collimation screws causes said mirror to move.

2. The apparatus of claim 1 further including a backing plate positioned between said diagonal back plate and said mirror, at least one of said plurality of collimation screws protruding through said diagonal back plate in contact with said backing plate.

3. The apparatus of claim 1 further including a backing plate positioned between said diagonal back plate and said mirror, at least one of said plurality of collimation screws protruding through said diagonal back plate in contact with said backing plate, said back plate having a high stiffness with a thin cross-section.

4. The apparatus of claim 1 wherein said plurality of collimation screws each include a narrow end portion and a threaded body, said narrow end portion received by a narrow opening in an inboard surface of said diagonal back plate whereby said plurality of collimation screws are prevented from being screwed through said diagonal back plate.

5. The apparatus of claim 1 wherein said pad is compressed by said collimation screws and applies pressure against said mirror, thereby allowing said plurality of collimation screws to move said mirror.

6. The apparatus of claim 1 wherein each one of said plurality of collimation screws is positioned on said diagonal back plate at an apex of a four-pointed diamond pattern.

7. The apparatus of claim 1 wherein each one of said plurality of collimation screws is positioned on said diagonal back plate at an apex of a triangular pattern.

8. The apparatus of claim 1 further including a protrusion on said diagonal back plate and said plurality of collimation screws include a pair of collimation screws, wherein said protrusion and each one of said pair of collimation screws is positioned on said diagonal back plate at an apex of a triangular pattern.

9. An apparatus for collimating a diagonal mirror for a telescope, said apparatus comprising:
an input port for receiving an optical signal, said input port adapted to mate with an output end of a telescope, said input port having an input axis;
an output port for transmitting said optical signal, said output port adapted to mate with a telescope accessory, said output port having an output axis;
a diagonal body attached to said input port and said output port with said input axis oriented at a specified angle with said output axis, said diagonal body having a body opening adjacent a cavity;
a mirror positioned adjacent said input port and said output port in said cavity of said diagonal body, said mirror being a first surface mirror, said mirror reflecting said optical signal between said input port and said output port;
a resilient pad positioned adjacent said mirror;
a plate covering at least a portion of said body opening, said plate attached to said diagonal body, said plate having a plurality of plate openings; and
a plurality of collimation screws each engaging one of said plurality of plate openings, said plurality of collimation screws each engaging a threaded opening such that rotating said plurality of collimation screws moves said mirror thereby compressing said resilient pad whereby rotating one of said plurality of collimation screws results in said mirror tilting.

10. The apparatus of claim 9 wherein said plurality of plate openings are threaded, and said resilient pad positioned between said mirror and a ledge inside said diagonal body, whereby said plurality of collimation screws push said mirror against said resilient pad, thereby compressing said resilient pad.

11. The apparatus of claim 9 wherein said mirror includes a mirror base and a reflective surface, said mirror base having a plurality of threaded openings for receiving said plurality of collimation screws, said resilient pad positioned between said mirror and said plate, where said plurality of collimation screws pull said mirror against said resilient pad, thereby compressing said resilient pad.

12. The apparatus of claim 9 further including means for preventing distortion of said mirror.

13. The apparatus of claim 9 wherein each one of said plurality of plate openings is positioned on said plate at an apex of a triangular pattern.

14. The apparatus of claim 9 wherein each one of said plurality of plate openings is positioned on said plate at an apex of a four-pointed diamond pattern.

15. apparatus for collimating a diagonal mirror for a telescope, said apparatus comprising:
a diagonal body having a barrel and a holder, said barrel having a barrel axis, said holder having a holder axis, said diagonal body securing said barrel and said holder such that said barrel axis and said holder axis intersect at a specified angle, said diagonal body having a cavity;
a back plate with a plurality of fasteners for securing said back plate to said diagonal body, said back plate adapted to cover said cavity, said back plate having a plurality of through-openings;
a mirror having a mirror base and a reflective surface, said mirror base having a plurality of threaded openings on an end opposite said reflective surface, said reflective surface reflecting light traveling along said barrel axis to said holder axis, said reflective surface being a first surface mirror;
a pad positioned between said mirror base and said back plate, said pad being resilient; and
a plurality of collimation screws, a threaded portion of each one of said collimation screws passing through said plate and said pad and being received in one of said plurality of threaded openings in said mirror base, said plurality of collimation screws causing said pad to be compressed between said plate and said mirror base, whereby an adjustment of one of said plurality of said collimation screws causes said mirror to move.

16. The apparatus of claim 15 wherein each one of said plurality of collimation screws is positioned on said back plate at an apex of a triangular pattern.

17. The apparatus of claim 15 wherein each one of said plurality of collimation screws is positioned on said back plate at an apex of a four-pointed diamond pattern.

18. The apparatus of claim 15 wherein said pad is compressed by said collimation screws and pushes said mirror away from said plate, thereby allowing said plurality of collimation screws to move said mirror.

19. The apparatus of claim 15 wherein said reflective surface is on a substrate attached to said mirror base.
